(19) United States
(12) Patent Application Publication
(10) Pub. No.: US 2006/0030251 A1
(43) Pub. Date: Feb. 9, 2006

(54) Modular belt shaped to fit the shape of a loin

(75) Inventors: Yvon Dufour, Saint-Anselme (CA); Marcel Couture, Saint-Henri (CA); Danny Lord, Levy (CA); Jean-Guy Roy, Saint-Anselme (CA)

Correspondence Address: ROBIC, CENTRE CDP CAPITAL, 1001, VICTORIA SQUARE - BLOC E - 8TH FLOOR, MONTREAL, QC, H2Z 2B7, CA

(73) Assignee: G.-E. LEBLANCE INC.

(21) Appl. No.: 11/182,839

(22) Filed: Jul. 18, 2005

(30) Foreign Application Priority Data
Jul. 20, 2004 (CA) 2 475 134

(51) Int. Cl. A22C 18/00

(52) U.S. Cl. 452/171

(57) ABSTRACT

Disclosed is a belt for conveying loins attached to flanks in a loin puller equipment. This belt comprises one or more driving chains and a plurality of modules for supporting the loins, which are mounted in parallel relationship over all the length of the chains. These modules are in the form of blocks preferably made of rigid Nylon, which extend transversally to the chains and are provided with an upper surface that is round-shaped and recessed in order to receive and hold the parts of the loins where the fat is located. The blocks are advantageously interchangeable and then adaptable to the size of the loin to be cut. The belt is therefore easily modifiable as a function of the product to be processed. It is also easy to manufacture and install and much easier to maintain. The belt permits to convey loins that are not yet separated from the adjacent flanks without any risk of friction or scrapping, as is the case with the existing belt.

### FIELD OF THE INVENTION

The present invention relates to a modular belt devised to be used in an equipment for automatically removing the backfat of a loin while said loin is still connected to a flank.

### BACKGROUND OF THE INVENTION

In order to illustrate what are a loin and a flank and what is the kind of equipments that may be used for processing the same, reference can be made to U.S. Pat. No. 6,336,856 granted on Jan. 8, 2002 in the name of the Applicant. It is worth noting that the common name of this kind of equipment is “loin puller”.

It is known in the food industry to use loin pullers for treating loins and flanks of pork. It is also well known that there are two kinds of loin pullers. The first one is devised to process a loin after it has been separated from the flank. The other one is devised to process a loin while it is still attached to the flank.

The present invention especially applies to the second kind of equipment, which is disclosed in the above-mentioned U.S. Pat. No. 6,336,856 of Jan. 8, 2002 and is commonly called “American loin puller” in the market.

One of the problems associated with the American loin pullers is related to the fact that the piece of meat moving along the same is much bigger and heterogeneous than a loin separated from the adjacent flank, as is the case in the first kind of equipment.

One of the keys for proper operation and profitability of the equipments that are used for processing loins and flanks attached altogether is to ensure that, during motion of the piece along the equipment, the loin always remains in the same position within the equipment until it reaches separation knife(ves) used to separate the backfat from the loin and the loin from the belly. The loin must actually have a very precise position at the inlet of the machine and not be subject to any change in its position until the knife(ves) have completed their separation.

In this kind of equipment, it is already of common practice to use a conveyor having a recessed upper surface so that the loin portion of the loin and flank assembly be positioned and stabilized during its motion within the equipment. However, when the loin is moved onto such a recessed conveyor, the remaining part of the piece of meat may have some to its surface in contact with one side of the frame of the equipment or onto a guide, which can cause a displacement of the loin due to a friction of it on the equipment or guide. The position where such a friction of the piece of meat with the equipment may occur is illustrated by way of example in FIG. 6 of U.S. Pat. No. 6,336,856, as item 45.

Depending on the temperature of the piece of meat, the kind of refrigeration, the genetics and the thickness of the backfat, the friction may cause a motion of the muscular and bone mass of the loin, which can result in a lower efficiency of the cut achieved with the knife(ves) as well as a poor performance of the equipment. By way of example, the blade bone can be moved together with the loin or be pulled up by excessive tension toward the external part of the machine and be cut by the knife(ves), which is a cause of problem for further processing the flanks or bellies.

It has already been suggested to use a lateral support for maintaining the loins and any other piece of meat such as loins, bellies or flanks connected thereto during their motion along the working surface. As an example of such kind of support, reference can be to U.S. Pat. No. 5,725,424 granted on Mar. 10, 1998 also in the name of the Applicant.

It is obvious that the shape and desired profile that must be taken by the loin and flank as is disclosed in U.S. Pat. No. 6,336,856 in the name of the applicant, call for reducing as much as possible the risk of friction on the piece of meat as such.

### SUMMARY OF THE INVENTION

It has now been discovered that the above-mentioned problems may easily be removed by using a conveying belt comprising one or several driving chains over the full length of which are mounted a plurality of loin supporting modules, in parallel relationship. These modules are in the form of blocks that extend transversally to the chain(s) and are each provided with a round-shaped, recessed upper surface sized to receive and hold the portion of the loins where are located the fat.

In accordance with a preferred embodiment of the invention, the blocks are preferably made of a rigid plastic material such as Nylon, and they are mounted in a detachable manner in order to be easily interchanged as a function of the size of the loins to be cut. This modularity gives a high versatility to the belt.

As may therefore be appreciated, the belt according to the invention has several advantages as compared to the conventional belts.

First of all, the belt according to the invention permits to achieve a positive 100% traction at the level of the bellies and/or the flanks and loins, without any risk of friction on the frame of the equipment. In other words, the belt permits to transport the loin and flank even if not separated without any friction or scrapping.

Secondly, the belt according to the invention can easily be modified as was explained hereinabove. Contrary to the conventional belts that are mounted in a permanent manner onto the frame of the loin puller, the belt according to the invention uses modular blocks that are easily interchangeable for adaptation purpose depending on the products to be carried. The belt according to the invention is therefore much more flexible.

Thirdly, the belt according to the invention is much easier to clean and thus more sanitary. Indeed, there are much less places that are susceptible of keeping pieces of meat. The belt according to the invention therefore makes the maintenance of the equipment much easier to carry out.

Fourthly, contrary to the conventional belts, it is not necessary to proceed to a complete dismantling of one side of the machine in order to replace the belt by another. One has just to disassemble its chain(s).

Moreover, the maintenance of the belt is much simpler and easier, since use is made of one or several chains as moving means. The rotation of the chain(s) can therefore be carried out with conventional elements that are easy to obtain and easy to replace whenever needs be.

Last of all, due to the fact that the belt according to the invention is provided with one or more chain(s), it is not subject to risk of elongation due to heat, as is the case with the existing belts. Moreover, it is much more resistant that the existing belts that are subjected to risk of tearing.

### BRIEF DESCRIPTION OF THE DRAWINGS

The invention will be better understood upon reading the following non-restrictive description of a preferred embodiment thereof, made with reference to the accompanying drawings wherein:

FIG. 1 is a side view of a modular belt according to the invention for use in a loin puller;

FIG. 2 is an enlarged cross-section view taken along line 11-11 of the belt shown in FIG. 1; and

FIG. 3 is a partial view similar to FIG. 2, showing how the modular belt according to the invention permits to hold a loin during its conveying.

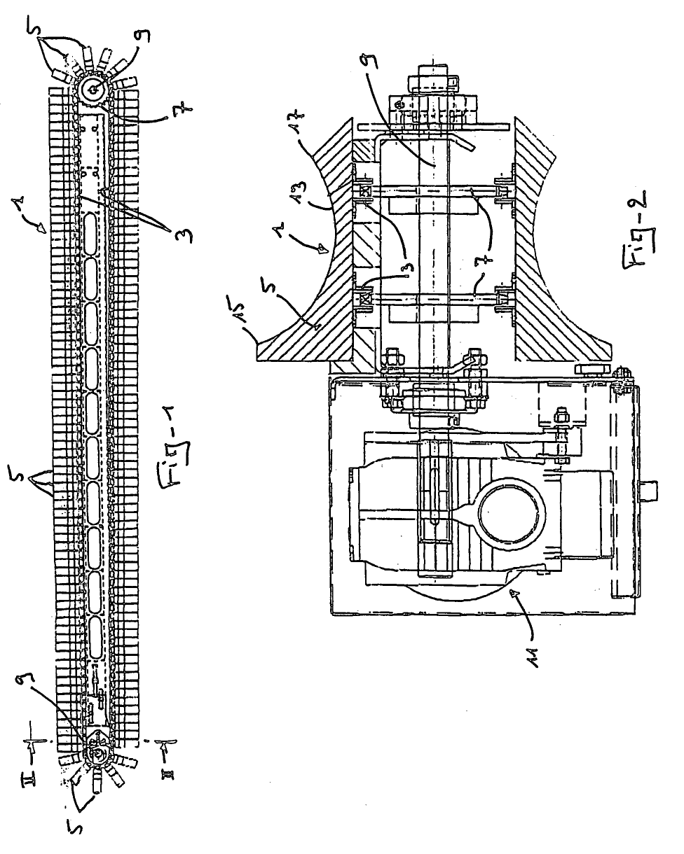

### DESCRIPTION OF A PREFERRED EMBODIMENT

The modular belt 1 for a loin puller as shown in the accompanying drawings is specifically devised to be used in an American loin puller, that is a loin puller wherein the flank is not completely separated from the loin before the loin moves below a U-shaped knife whose purpose is to separate the back fat from the loin and separate the loin from the belly. An example of such an American loin puller is disclosed in U.S. Pat. No. 6,336,856 already mentioned, that was granted in the name of the Applicant.

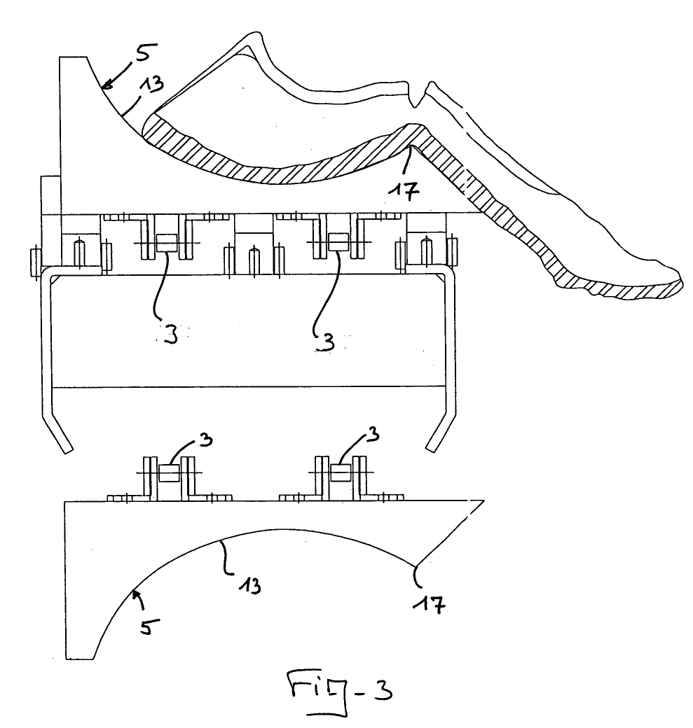

In the illustrated embodiment, the belt 1 comprises two driving chains 3 over the full length of which a plurality of modules are mounted in parallel relationship for supporting the loins. The modules are in the form of blocks 5 preferably made of rigid Nylon, which extends transversally to the chains 3 and are each provided with an upper surface 13 that is round-shaped and recessed in order to receive and hold the portion of the loins where is located the fat (see FIG. 3).

Each block 5 has one side 17 of its upper surface 13 that is lower than the other side 15. The lower side 17 is also bevelled downwardly and externally in order to receive the loins when these loins are still attached to the adjacent flanks and therefore allow these flanks to fall down on one side of the belt while said loins are subjected to a cutting in an American loin puller, without risk that the round-shaped recessed portion of the upper surface and the adjacent bevelled side of said upper surface forms a friction or scrapping edge. Indeed, contrary to the prior art equipment, this part of the belt moves together with the same and therefore with the loins. The way the loins and flanks connected to the same are positioned onto the edge of the bevelled side 17 of the blocks 5 is illustrated in FIG. 3.

Advantageously, the blocks 5 are mounted in a detachable manner onto the chains 3 in order to be interchanged as a function of the size of the loins to be cut.

The chains are also mounted on and driven by toothed wheels mounted onto shafts 9 connected to a motorized driving means 11.

As previously indicated, the modular belt according to the invention, thanks to its structure and installation, permits a positive 100% traction of the flank and loin.

This belt is also very easy to install and remove. Indeed, one has only to disassemble the chain(s) in order to remove the whole belt from the loin puller.

It is therefore not necessary to dismantle one side of the equipment in order to have access to the belt for maintenance purpose.

Due to the fact that the belt comprises blocks made of rigid Nylon mounted on one or more metal chain(s), it is not subject to any problem of elongation due to the heat.

Thanks to its structure, the belt is also easy to clean. Moreover, it comprises much less places that unwanted pieces of meat may be held and retained.

As previously indicated, the blocks are interchangeable. Therefore, they can easily be adapted to the size of the loins and flanks to be cut.

Of course, numerous modifications could be made to the invention as it has been disclosed, without departing from the scope of the invention as defined in the accompanying claims.

1. A belt for conveying loins attached to adjacent flanks in a loin puller equipment, wherein said belt comprises at least one driving chain and a plurality of loin supporting modules mounted in parallel relationship over all the length of said at least one driving chain, said modules being in the form of blocks that extend transversally to said at least one chain and are each provided with a round-shaped, recessed upper surface sized to receive and hold part of a loin.

2. The belt according to claim 1, wherein the upper surface of each block has two opposite sides, one of said sides being lower than the other one and bevelled externally downwardly in order to receive the loins that are still attached to their adjacent flanks and thus to permit to the flanks to fall down on said one side of the belt when the loins are subjected to a removal of fat in the loin puller equipment.

3. The belt according to claim 1, wherein the blocks are mounted in a detachable manner in order to be easily interchanged as a function of the size of the loins to be cut.

4. The belt according to claim 2, wherein the blocks are mounted in a detachable manner in order to be easily interchanged as a function of the size of the loins to be cut.

5. The belt according to claim 1, wherein the blocks are made of rigid plastic material.

6. The belt according to claim 2, wherein the blocks are made of rigid plastic material.

7. The belt according to claim 3, wherein the blocks are made of rigid plastic material.

8. The belt according to claim 4, wherein the blocks are made of rigid plastic material.
